(19) United States
(12) Patent Application Publication
(10) Pub. No.: US 2015/0029041 A1
(43) Pub. Date: Jan. 29, 2015

(54) DEVICE, SYSTEM AND METHOD FOR CAPTURING MOTOR VEHICLE BEHAVIOR

(71) Applicants: Calvin John Liu, SAN FRANCISCO, CA (US); Manohar Raghunath Kamath, FREMONT, CA (US)

(72) Inventors: Calvin John Liu, SAN FRANCISCO, CA (US); Manohar Raghunath Kamath, FREMONT, CA (US)

(21) Appl. No.: 14/338,351

(22) Filed: Jul. 23, 2014

Related U.S. Application Data
(60) Provisional application No. 61/858,433, filed on Jul. 25, 2013.

(51) Int. Cl. G08G 1/14

(52) U.S. Cl. CPC G08G 1/143
USPC 340/932.2

(57) ABSTRACT

A novel fixed communication device includes a locator unit to receive and process information regarding current location, a sensing unit to determine parking status based on proximity of driver to fixed device and a wireless communication unit for information transfer to and from any mobile communications device. The system includes the fixed communications device which is coupled with a software program on a mobile communications device to gather and transmit parking information. A method includes logging parking behavior and parking location of a vehicle as determined by the fixed communications device, with data gathered to be stored in a central server for social communication purposes.

### CROSS RELATION TO RELATED APPLICATION

The instant application claims priority to pending U.S. provisional application 61/858,433 filed on 25 Jul. 2013. The pending U.S. Application 61/858,433 is hereby incorporated by reference in its entireties for all of its teachings.

### FIELD OF THE INVENTION

The present invention relates to a device, system and method for capturing motor vehicle behavior. More specifically the device is a fixed hardware communications device in particular and software on mobile communications devices in general. The invention is able to gather parking behavior without requiring user proactive action.

### BACKGROUND OF THE INVENTION

Of late, automobiles and trains have become more electronically driven, namely drive-by-wire, rather than as a fully mechanical medium. Due to this fact, digital information about the health and status of the vehicle can be collected reliably from the on-board computing system and various monitoring sensors that are present throughout the vehicle.

On-Board Diagnostic (OBD) systems are in most cars and light trucks today. OBD-II is a new standard introduced in the 90's that provides complete engine control and monitoring data for diagnostic purposes.

Similarly, European On-Board Diagnostics (EOBD) provides the European equivalent of OBD-II that applies to all M1 category cars that have no more than eight passenger seats and weights of 2500 Kg or less. Each EOBD code contains five characters that clearly refer to data of a subsystem within a vehicle.

So far, on-board diagnostics data have been used only for fault diagnostic purposes. However, with an interface made available, the data can be used for managing other intelligent applications in addition to monitoring the health of the vehicle. It is important to note that the OBDII port acts as a power source as well.

In this submission, we submit an invention, a device that when interfaced with the vehicle subsystem collects and manages important applications such as navigation, parking, after-market add-ons and security/monitoring.

Presently, the data gathered from the OBD-II port is used for diagnostic purposes, and not for navigation and history of the vehicle behavior. External devices are used for rudimentary navigation data, without taking into account important data from the vehicle itself. In this invention, we use the vehicle data for better navigation.

A basic requirement to operating an automotive vehicle is a place to park said vehicle when not in use. Metropolitan cities are a nightmare for parking not only for regular drivers but also for tourists. Specifically if there is an event it becomes exceedingly difficult to find parking and find a reasonably priced place to park.

With changing local parking rules it is impossible for any individual to be aware of recent changes of rules and regulations. This leads to monetary burden for many individuals receiving parking tickets and/or tow away costs. Aizenbud et al. (2009, EP2268504A2) does not use a fixed communication device to determine parking status or location. Joseph P. Quinn (2007, US20080048885) does not have a novel fixed communication device that performs a deterministic driver behavior prediction using a hardware proximity sensor. Everett et. al. (2012, U.S. Pat. No. 8,311,858) data gathered is not associated with parking or parking status. There is a need for efficient management of time, determining the availability of parking spots and money as far city parking is concerned.

Presently, the vehicle diagnostic data is available through direct connection to the vehicle OBD-II port through a hand-held monitor. The monitor is very rudimentary which displays only a code and the technician needs to convert the code to the issue through a manual that translates the code for various vehicle make/model. We propose an “after-market” system that can intelligently communicate the data which can be managed remotely.

Presently, in trucks and trains where sensitive and hazardous cargo is sent, drivers are required to be present in the vicinity all the time. However there is no mechanism to track exactly if the driver is always near the vehicle or not. Video transmission is very cumbersome requiring continuous monitoring. The proposed invention can directly be applied in the explained case.

### SUMMARY

The invention discloses a device, system and method for communicating with the vehicle and the user for predicting parking spots, seeking parking in high density areas, showing the availability of parking to a particular user, the ability to analyze historical parking behavior facilitates more efficient searching for parking and security analysis. The ability to gather parking behavior with no user proactive action facilitates the gathering of historical parking behavior is achieved using the device, system and method of the instant invention. In one embodiment, an ability to deterministically predict when a specific parking space is about to be vacated allows more accurate search for parking. The social communication of parking information, particularly information like parking availability before vacancy actually occurs, improves the search for parking.

In one embodiment, a device, a system and a method is used for gathering, sharing parking behavior and performing deterministic prediction of available parking slots. In another embodiment, a communication device (fixed or mobile) which comprises a locator unit to receive and process information regarding a current location, a sensing unit to determine parking status based on proximity of user to fixed device, and a wireless communications channel to provide information transfer to and from any mobile communications device.

In one embodiment, the device is coupled with a software program on a mobile communications device which provides the user interface and a parking data storage server as a method and system. Further, in accordance with another embodiment, the sensing unit includes means to operate without proactive user input.

Moreover, in accordance with an embodiment, the fixed/mobile communications device unit is at least one of a pairable wireless communications chipset and a GPS chipset. In one embodiment, the mobile communications device upon which the software component operates is a wireless data enabled mobile telephone, but can be any mobile device with wireless data communication capability such as a tablet, PDA, laptop, and so forth.

In another embodiment, the parking status determination unit includes a hardware capability to predict expected changes in the parking status based on user proximity to vehicle in which said fixed communication device is installed.

Still further, in accordance with one embodiment, the parking status of a vehicle is determined by the driver leaving the immediate physical proximity of the vehicle as determined by the fixed communications device, with future availability of the parking space said vehicle is occupying to be determined by the driver returning to physical proximity of the vehicle. In another embodiment, the distance from the fixed communication device and the driver device determines the code for vacancy and/or occupancy.

In one embodiment, a fixed communications device comprising of at least one of a locator unit to receive and process information regarding a current location, a wireless communication unit for transmitting a data and a sensing unit to determine parking status based on proximity of a driver device to the fixed communication device; and a mobile communication device for information transfer to and from the fixed communications device.

In one embodiment, a method as an initial set up a driver communication module (DMCD) is paired with a fixed communication device (FCD) and the fixed communication device (FCD) or also called a driver device. In another embodiment, the software operates in the back ground of the DMCD. The FCD is paired with DMCD and when it is in range the parking status is =0, means that it is not parked. In another embodiment, if FCD pairing to DMCD is lost (out of range), then Parking Status=1 (parked). Parking Status and Time written to Parking Data Storage Server and the communication is relayed to Parking Data Storage Server using the Internet. In another embodiment, if FCD is not paired to DMCD (out of range), then Parking Status=1 (parked) and the driver device is informed about the status. As a next step, if FCD pairing to DMCD is found (back in range), then Parking Status=2 (parking about to be available). Parking Status and Time written to Parking Data Storage Server. Constant update of the data from the FCD and DMCD and/or driver device enables the members to be aware of the parking spots and other details. One may also predict based on historical user data, location and city about a potential spot being available and allow the user to reserve it.

In one embodiment, If FCD pairing to DMCD is found (back in range), then Parking Status=2 (parking about to be available). Parking Status and Time written to Parking Data Storage Server. In another embodiment, If Parking Status=2 and either ignition=on or engine=on, then Parking Status=3 (parking availability confirmed). Parking Status and Time written to Parking Data Storage Server.

Essentially, AutoAide platform is intended to provide hardware and software base for four areas of applications, namely Navigation, Parking, After-Market and Security which purely a smartphone/app based platform cannot provide. In particular, smartphone GPS is poor and is diverging from state of the art GPS. This poor GPS accuracy is more or less sufficient for navigation, but is entirely insufficient for parking. It is also extremely unlikely that the smartphone GPS capabilities will catch up in the future—there are platform issues primarily involving power. GPS chipsets consume large amounts of power both in processing and in the RF GPS signal acquisition. Instant device (AutoAide) solves this problem by enabling state-of-the-art GPS which runs off the automotive power systems and imports the GPS seamlessly into the smartphone operating systems.

AutoAide also solves important problems that are endemic to smartphone/app platforms, namely, automatic determination of parking status, navigation, after-market support of vehicle metrics into devices and security monitoring.

AutoAide uses Bluetooth connection over which GPS signals are exported to the smartphone, to serve as a switch. If Bluetooth is connected, the driver is in the vehicle. If the Bluetooth is disconnected, the driver is away from the vehicle, and the vehicle is parked. This provides greater accuracy in determining the proximity of driver to the vehicle. This is very useful in monitoring if the driver is near the truck or train that carries important cargo where legally the security person's proximity to the cargo is mandatory at all times.

The power source for AutoAide is via OBD-II port, which is standard in all cars in the US post 1995. Besides power, the OBD-II port allows access to the vehicles information systems which can also be used to add additional nuances to parking services. AutoAide platform thus enables automated services for parking via the improvement of GPS accuracy and automated, accurate determination of parking status.

The determination of parking status also enables automated detection of when drivers return to their car, which in turn feeds automated sharing of parking, i.e., space about to be vacated by departing driver. These data are collected and reported to the server real-time.

Accurate determination of parking status along with parking location yields the base data needed for historical parking information. This is where the server is utilized, where the smartphone data connection through the service provider is used to bring in parking regulation and cost data for user consumption, behavior and other important metrics.

For navigation, the above capabilities are used for more accurate Big Data collection, where the access to the vehicle systems enable much more nuanced data collection, such as when, how much acceleration and braking, access to vehicle odometer and speed sensors. This is used for forensic analysis as well. The improved GPS accuracy also enables land-specific analysis as opposed to route specific, which is prevalent today.

Historical data in the server is used for studying historical patterns leading to avoidance of parking tickets, occupancy of parking spaces and the city's expansion in future parking capacity.

AutoAide can find potential parking spot with greater probability in an area based on past analysis. AutoAide parking will be able to automatically pay the parking meter, not just add the value. Users can avoid parking tickets by having the AutoAide integrated into their system that provides reminders. AutoAide can accurately determine vehicle's location, and automatically identify the meter and initially pay as well as follow on pays be automatically debited. Data analysis of the user pattern is used by the authorities to expand new parking space build up and increase revenue.

In one embodiment, the instant design, system and method of a communication device in a vehicle to provide new intelligent applications for capturing motor vehicle behavior that can be accessed through smart devices. In another embodiment, the fixed communication device gathers parking behavior and doing so with fixed hardware in particular and software on mobile communications devices in general. The invention is able to gather parking behavior without requiring user proactive action. Parking behavior stored in a central server can then be shared socially.

The fixed communication device (device) uniquely connects to existing automobile infrastructure and seamlessly collects navigation data to provide lane specific routing. In the absence of GPS accuracy, the device accurately determines available parking spots, future availability of parking spots, and provides clear parking directions to enable parking management. The device extends the after-market vehicle add-ons by providing important vehicle system data through wireless interfaces and by serving as a wireless router. The device also provides security and safety monitoring functionality, where automobile drivers in vehicles such as trucks or trains can be monitored. Other features will be apparent from the accompanying figures and from the detailed description that follows.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows the applications that the device can support, namely personnel monitoring, safety monitoring, and vehicle parking and navigation system.

FIG. 2 illustrates the high level design and the dependencies. The proposed AutoAide system interfaces with the vehicle diagnostic interface. The information is relayed to smart phones or other edge devices, in addition to Bluetooth enabled devices and sensors. The information collected is sent to a server that does the real-time data collection and analysis in addition to hysteresis and forensic data analysis.

FIG. 3 expands the AutoAide methodology, where using the standard interface—four applications, namely navigation, parking, after-market and security/monitoring, are supported.

FIG. 4 illustrates the vehicle installed Fixed Communication Device (FCD) that contains a sensing unit, locater unit and wireless communication unit. FCD communicates with mobile devices through wireless I/O to reach the parking server.

FIG. 5 provides the block diagram of the FCD hardware/software specification. FIG. 5 also shows an alternate block design to achieve the same purpose.

FIG. 6 depicts the parking tracking flowchart, where the parking status is updated based on information from FCD.

FIG. 7 shows the mobile communication device range related to FCD.

FIG. 8 illustrates a situation where the driver leaves the sphere of FCD's influence.

FIG. 9 illustrates the step where the driver/mobile communication device is out of range of FCD.

FIG. 10 shows the driver/mobile communication device is back in range of the FCD's sphere of influence.

FIG. 11 shows the system architecture of FCD where the hardware specifications are clearly given. Additional refinements to the method whereby car computer data as received through the SAE J1962 interface can be used to further refine the parking determination status.

FIG. 12 illustrates the parking prediction flowchart where the parking status is predicted based on engine parameters.

FIG. 13 shows an alternate version of the flow chart in FIG. 12 where parking availability is confirmed after parking “about to become available” status is achieved.

FIG. 14 shows an entire system for processing varied data and enriching the varied data, according to one or more embodiments.

FIG. 15 is a diagrammatic system view of a computer device 1500 view in which any of the embodiments disclosed herein may be performed, according to one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. A method, system and device for capturing motor vehicle behavior.

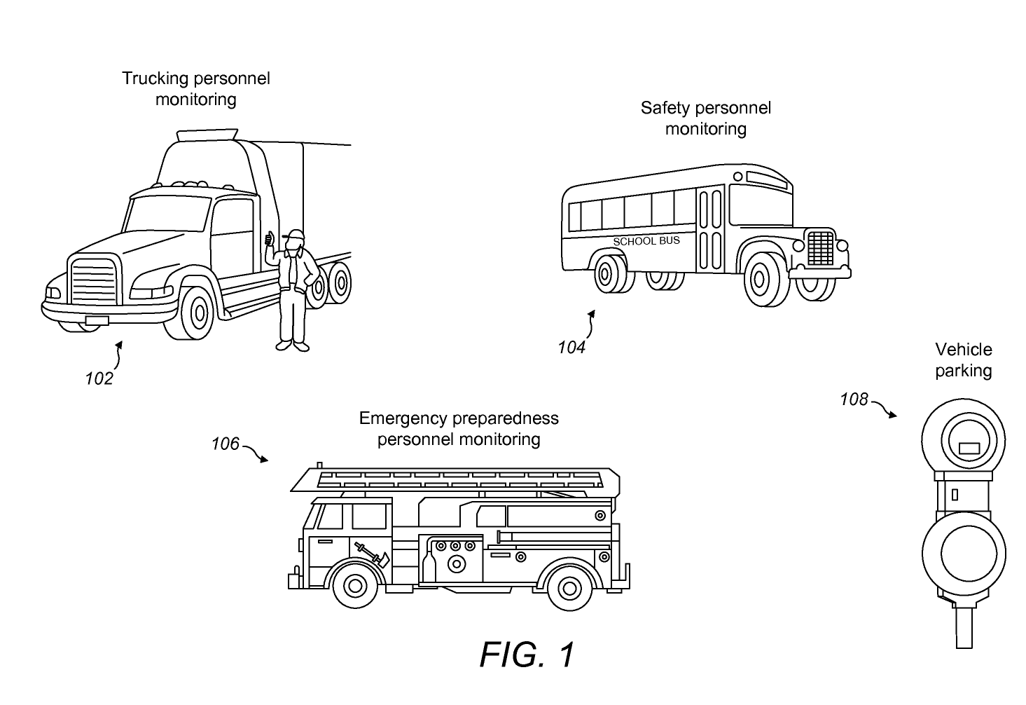

FIG. 1 shows the potential applications for the proposed patent. Trucks carrying hazardous material needs to have personnel in the vicinity. Unfortunately, GPS units are not very accurate and would show a driver close to the truck even if the driver is a few meters away. However, the proposed Fixed communication device with driver device (AutoAide) will be able to track the vicinity of the driver 102 using Bluetooth and record the presence all the time. Similarly, the vicinity of the school bus driver 104 can be monitored seamlessly. The proposed design can be used to relay navigation information to emergency vehicles 106 and monitor the movements of the personnel. The solution can also be used for vehicle parking management 108.

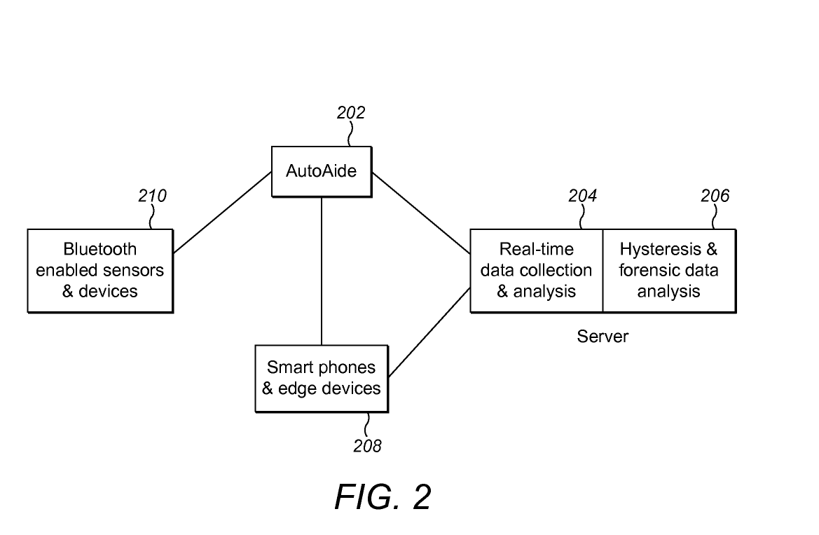

FIG. 2 illustrates the high level design dependencies of the AutoAide design. AutoAide/Parking: the AutoAide platform is intended to provide hardware/software capabilities which a purely smartphone/app based platform cannot. AutoAide 202 interfaces with the vehicle through the physical interface provided by the OBD-II or EOBD and is capable of communicating over wireless to the edge devices or smartphones 208. In addition AutoAide can provide After-market functions such as showing dashboard metrics and engine diagnostics directly to Bluetooth enabled smart devices 210. The data collected by AutoAide can be sent to a server in real-time for analysis 204. Backend of the server can provide intelligence by fine-tuning the results by conducting hysteresis and forensic analysis based on historical data 206.

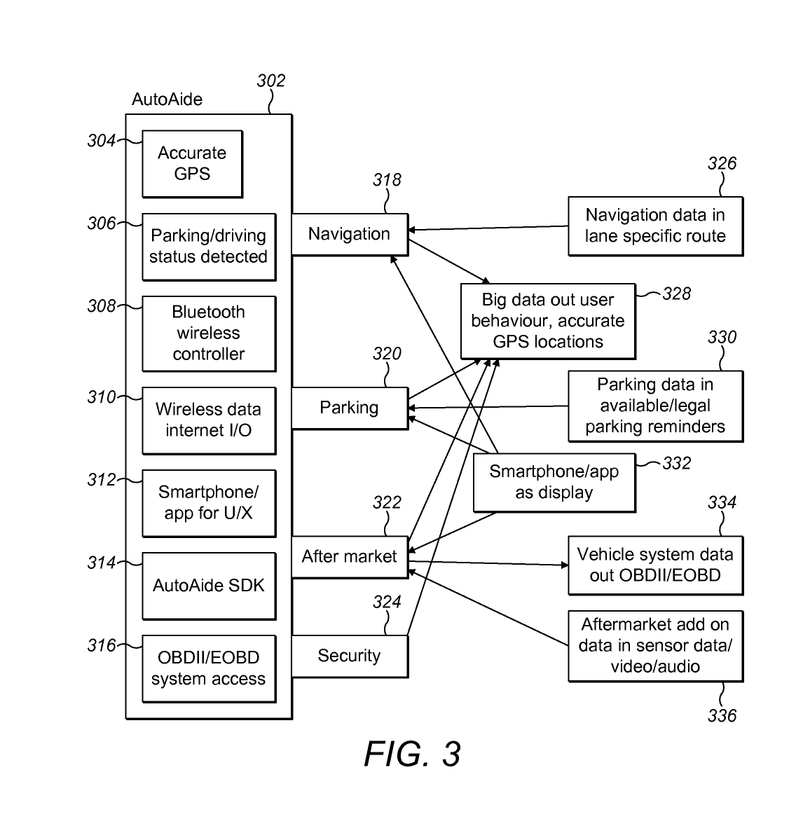

FIG. 3 expands the AutoAide 302 methodology. AutoAide interfaces with the physical interface in the vehicle through OBD-II and EOBD system access 316 to provide navigational module information 318. As mentioned earlier, the external GPS systems are not accurate enough to differentiate between the correct positions of the driver verses the vehicle. AutoAide replaces the GPS function 304, Parking/Driving status 306 within the vehicle system to support the Parking 320 application module. The Bluetooth wireless controller 308 functions and the SmartPhone/App for U/X 312 are used within the AutoAide for After-market 322 application module. Similarly the Bluetooth wireless controller 308 is used to check if the driver is within the vicinity of the vehicle to monitor the vehicle for security and safety purposes 324.

The Navigation module obtains the data 326 and calculates the user behavior and accurate GPS locations 328. For navigation, 328 is used for more accurate big data collection. The access to vehicle systems enables much more nuanced data collection such as when, how much acceleration and braking was done, and vehicle odometer information. The improved GPS accuracy 328 enables lane-specific analysis 326 as opposed to route specific analysis done today.

The parking application module 320 obtains the parking data information 330 and accurately determines parking status along with parking location 328. The smartphone 332 data connection is used to bring in parking regulation and cost data for user consumption and is used to transmit parking behavior 238.

The after-market application module 322 uses the Bluetooth 308 connectivity to provide the Bluetooth wireless router functionality. This enables Bluetooth enabled sensors or other devices can be used to augment/replace existing car dashboard displays systems with smart phone display 332 to provide information such as parking sensors, fog sensors, and driver displays. The data could be using audio, video or pure data format 336. The after-market module 322 directly interfaces with the OBD-II and EOBD interfaces 334 to collect the data.

The security application module 324 uses the Bluetooth connectivity of the edge device that the driver has to monitor the vicinity of the driver. It collects important user behavior data 328 and GPS 328 to establish driver's position near the truck or train. The data collected will be used in forensic analysis 206 when a situation arises.

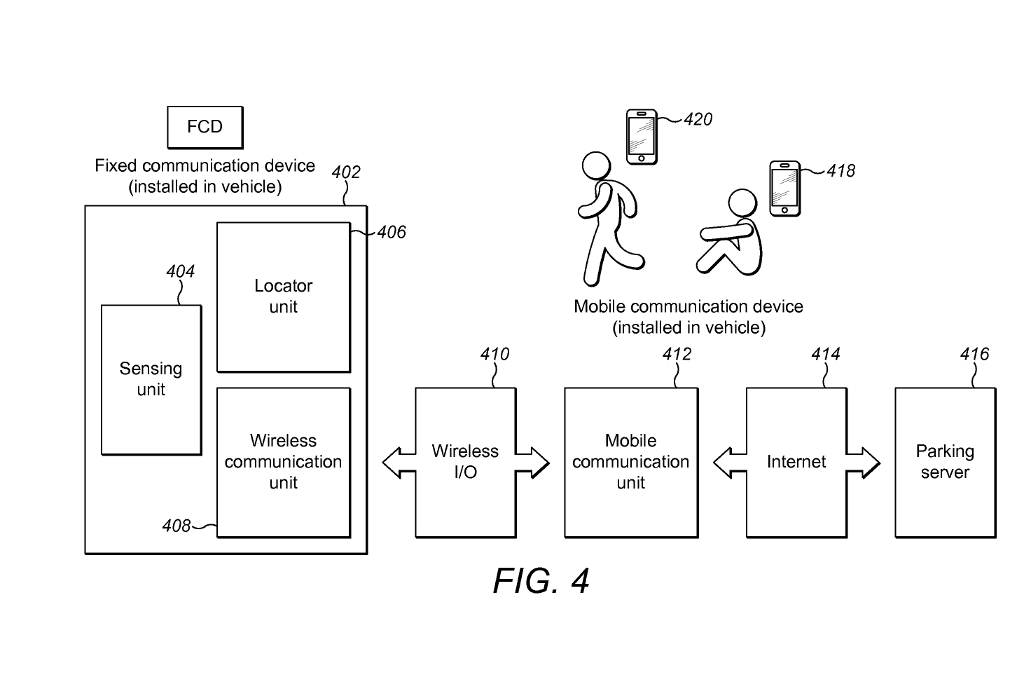

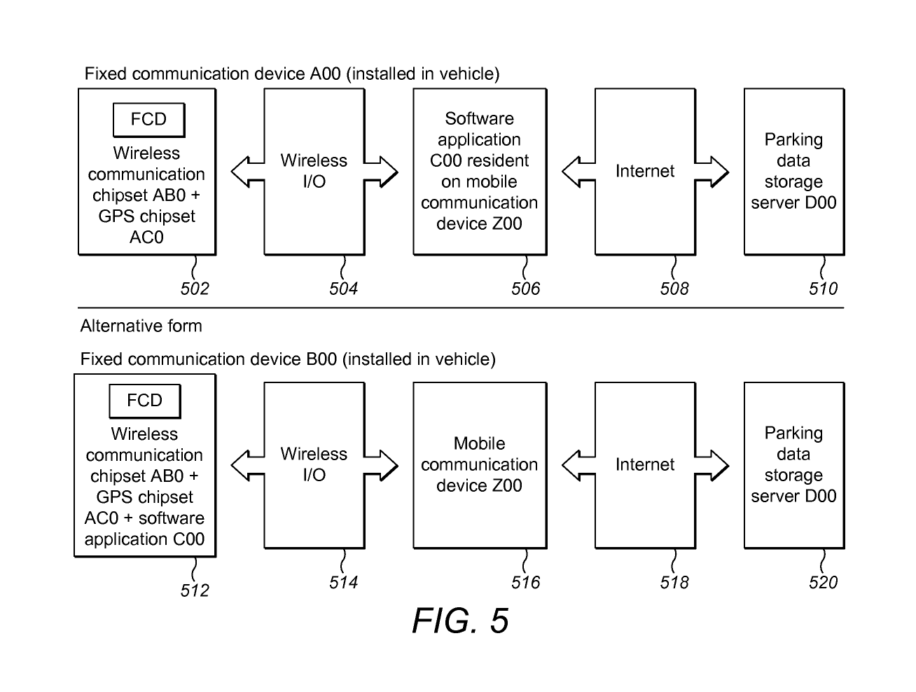

Reference is now made to FIG. 4, which illustrates a novel fixed communications device constructed and operative in accordance with one embodiment A00 as shown in FIG. 5. The FCD installed in vehicle 402 has the sensing unit 404, locater unit 406 and wireless communication unit 408. The interface to vehicle is OBD-II or EOBD. The FCD that provides the AutoAide function is directly connected the mobile communication device module 412, which is in driver's possession 420, 418 through the wireless I/O 410. Driver's device 418, 420 had Internet 414 connectivity through their service providers and the parking server 416 is connected to the Internet over cloud.

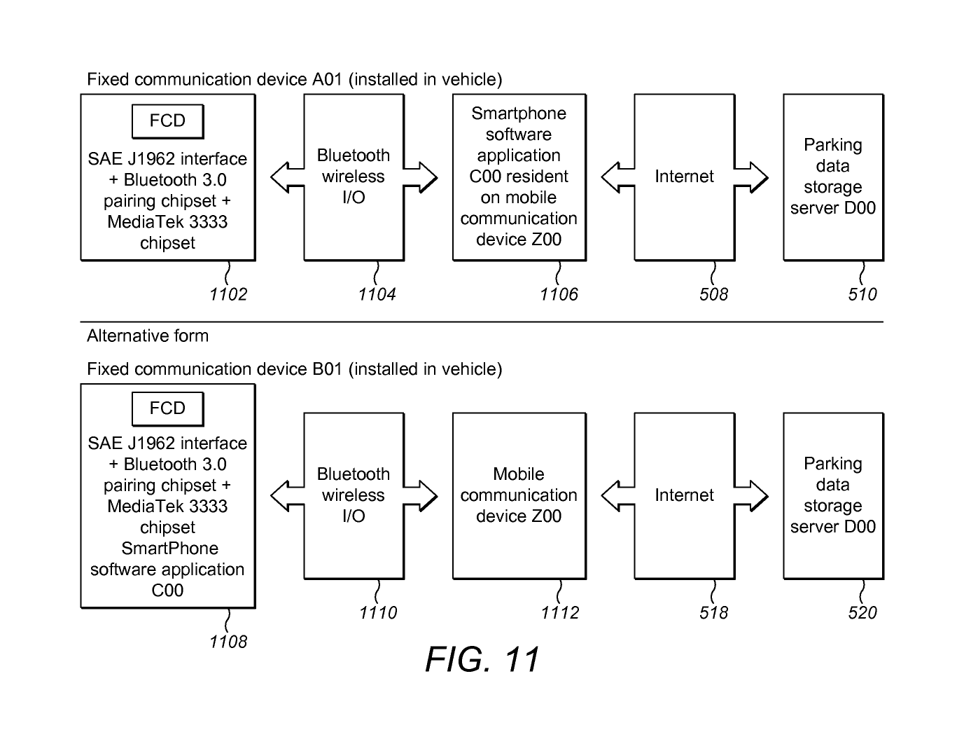

FIG. 5 also shows an alternate form of novel fixed communications device B00 constructed and operative in accordance with a one embodiment B01 as shown in FIG. 11 is also shown. Device A00 may comprise a wireless communications unit 502, a wireless communication chipset AB0, and a GPS unit AC0. GPS unit AC0, 502 comprises the locater unit for novel fixed communication device, and may provide location and timing parameters such as, for example, the time, location of device A00, the precision of GPS unit AC0 and the like. FCD 502 interfaces to the mobile device 506 through a wireless I/O interface 504. Software application C00 is resident on mobile device Z00. The mobile device 506 connects to the parking data storage server 510 through Internet 508. This enables the FCD 502 to communicate with parking data storage server 510.

FIG. 5 shows the alternate form of achieving the same, where the FCD 512 consists of a chipset AB0, GPS chipset AC0 and a software application C00. The software application in FCD 512 interfaces with the mobile device 516 Z00 through wireless I/O 514. The mobile device 516 connects to the parking data server 520 D00 through Internet 518 provided by service provider. Wireless communication unit 502 AB0 may facilitate transmission of data, signals and messages from device A00 to software interface 506 C00 as necessary. Wireless Communication unit AB0 may incorporate any communications protocol including Bluetooth 2.x, 3.x, 4.x; ZigBee; Wi-Fi; or other wireless communication standards or custom wireless communications protocols.

Wireless communication unit 512 AB0 plus software C00 on mobile communication device 516 Z00 comprise the sensing unit for novel fixed communications device. Wireless communication unit AB0, in order to communicate with mobile communication device Z00, must have an approved and open wireless connection configuration 514. This is commonly referred to as ‘pairing’. Once paired, a loss of connection will result in continuous monitoring by Z00 for the return of the approved wireless connection.

As novel fixed communication device 502 A00, which incorporates wireless communication unit AB0, is permanently installed in a driver's vehicle, and the driver's mobile communication device 506 Z00, in which software C00 is resident, is mobile, the wireless connection status is also a proxy for whether the driver's mobile communication device Z00, hence the driver, is within the wireless connection radius of AB0.

Thus wireless communication unit 512 AB0 plus software C00 monitors the pairing status for novel fixed communication device A00 to determine vehicle parking status because the driver being beyond a reasonable fixed distance from driver's vehicle is a reliable indicator that said vehicle is parked. Operation of this proximity detection feature can also be with the software and monitoring resident on the fixed communication device. Said proximity detection feature used to determine parking status—i.e. absence or return of driver—can also be used to determine presence of driver and serve as an initiator for other services. This proximity feature can also be used to determine presence or absence of mobile communications device and owner for any other location in which a fixed communication device is installed.

Novel fixed communication device 502 A00 plus software C00 resident on mobile communication device 506 Z00 also permits more power efficient location services. Location services on a mobile communication device 506 draws large amounts of power thereby reducing battery life. Novel fixed communication device 502 A00 enables the transmission of location information from the locater unit, via software C00, to replace location services available, but heavily power consuming, in the mobile communication device 506 Z00. Novel fixed communication device 502 A00 enables the offloading of power requirements of location services to a power source external to the mobile communication device.

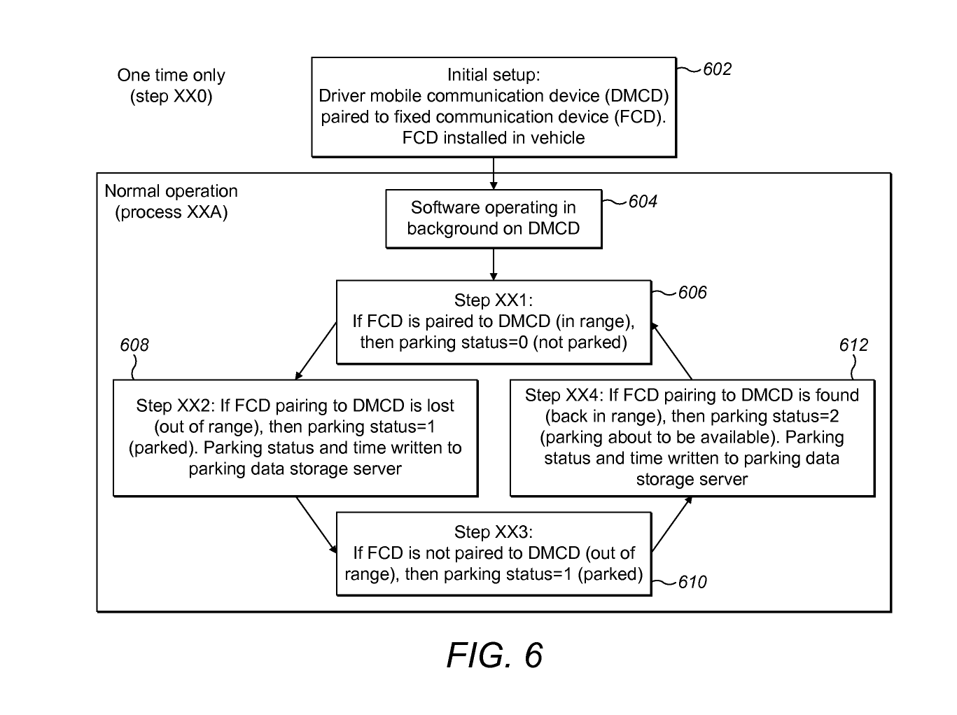

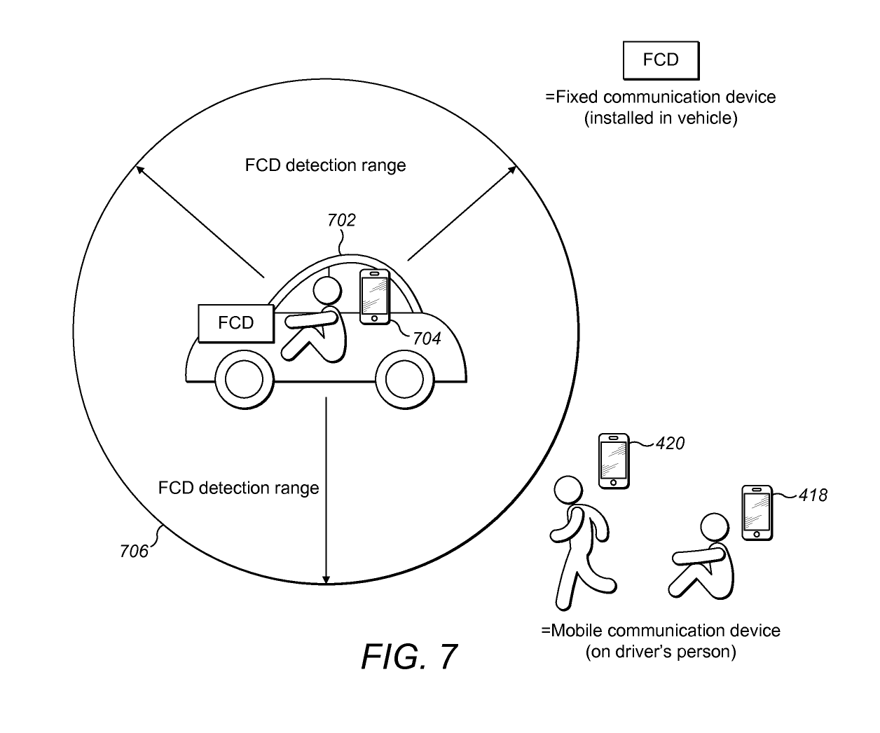

FIG. 6 shows the flow chart steps for parking tracking. The Driver Mobile Communication Device (DMCD) which is a smart edge device is paired to Fixed Communication Device (FCD) installed in the vehicle 602. The software operates in background on DMCD 604. If FCD is paired to DMCD (within the range), then the parking status is that the vehicle is not parked 606. FIG. 7 illustrates this step, where the FCD detection range shows that the DMCD 704 and FCD 702 are paired and within the range 706. The mobile unit 402 and 418 are in driver's possession. If FCD pairing to DMCD is lost (out of range) 608, then the parking is done. This means that the person has parked and left, therefore the parking status and time can be written to the parking data storage server.

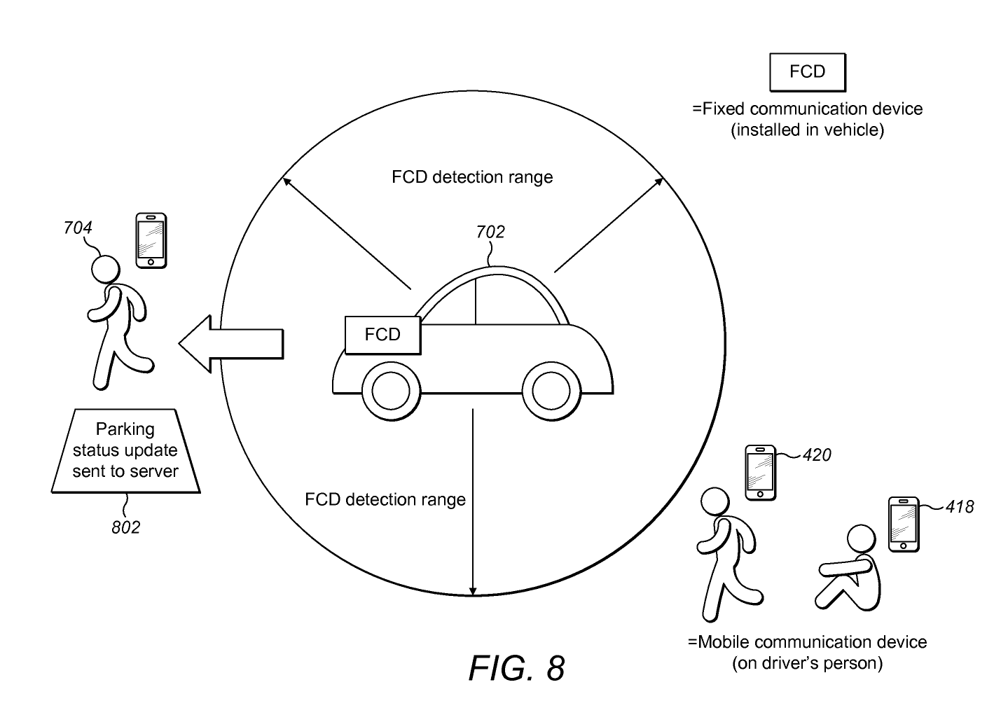

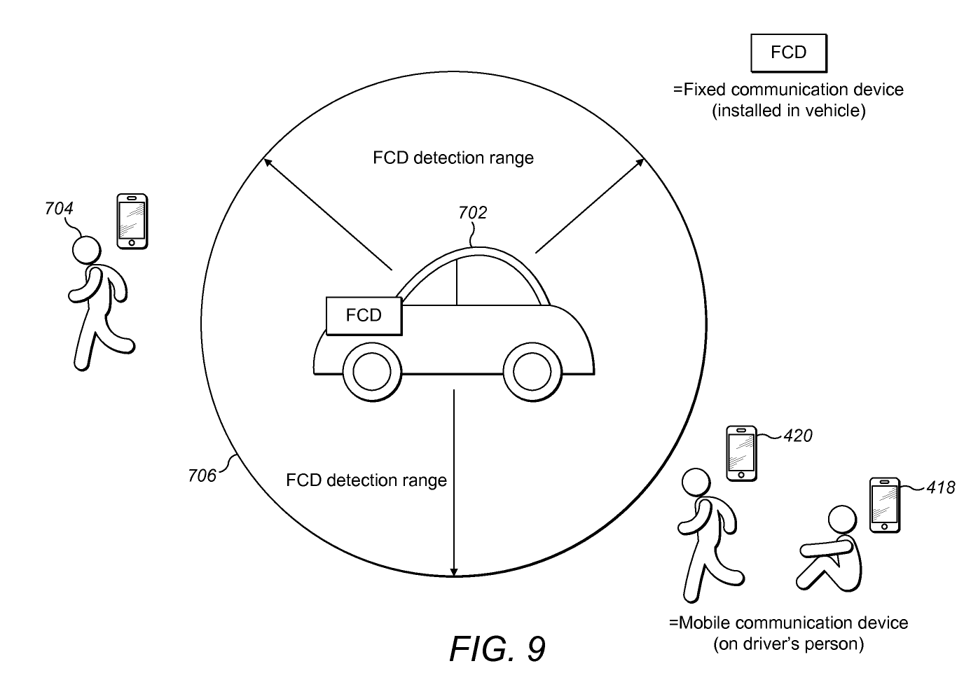

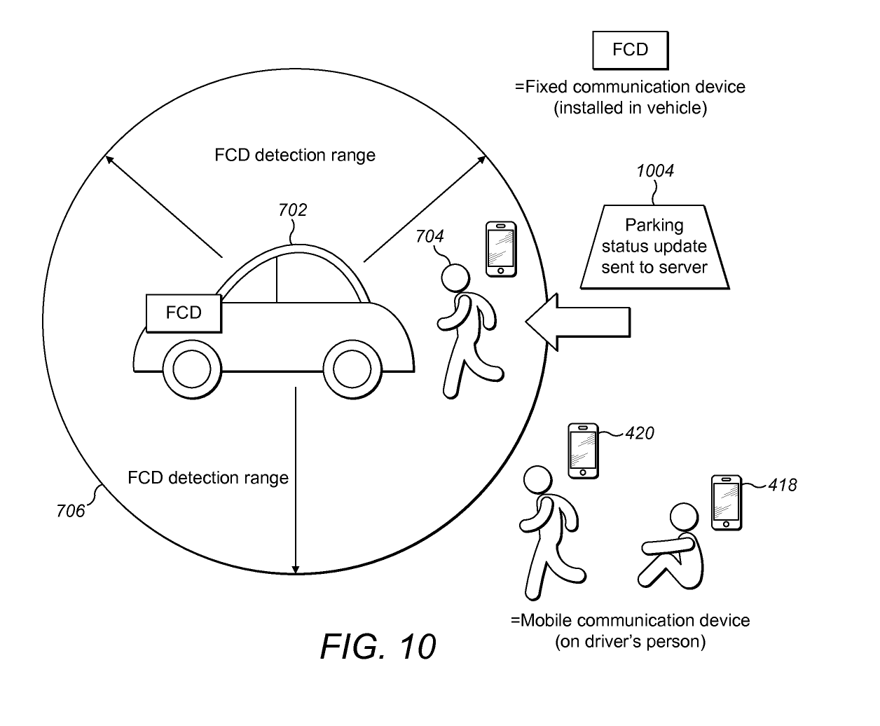

FIG. 8 shows this situation clearly where the FCD 702 is not paired with the DMCD 704 and is out of the FCD detection range 706. Hence the parking is inferred to be done, and the parking status is updated to the server 802. If FCD is not paired to DMCD because it continues to be out of range 610, the vehicle is deemed to be parked, and the status remains as parked. FIG. 9 illustrates this step where we can clearly see the FCD 702 is not paired any more with the DMCD 704 and not in the vicinity of FCD 702. If FCD finds that DMCD has approached back into the field of influence, then the parking status is changed from parked to “about to be available” 612. Both parking status and the time are written to the parking data storage server. FIG. 10 illustrates this step where the FCD 702 finds that DMCD 704 is within the FCD detection range 706, and therefore the parking status 1004 is updated.

FIG. 6, to which reference is now made, is a flow chart that illustrates an exemplary process XXA for identifying parking status using a device A00 (as shown in FIG. 5). It will be appreciated that device A00 is configured to run process XXA continuously after device A00 is initially set up. Process XXA requires no proactive input from a user. Once process XXA is started (step XX0), device A00 will check (step XX1) for a shift in parking status. Step XX0 602 will consist of the user installing novel fixed communication device A00 into their vehicle, initiating a wireless pairing with user's mobile communication device Z00, and opening software 604 C00 as shown in FIG. 6.

FIG. 7, to which reference is now made, demonstrates Step XX1 606 which will consist of: For present wireless communication pairing status=1 (paired), if pairing status check=1 (paired), then status of parking is set to 0 (not parked).

FIG. 8, to which reference is now made, demonstrates Step XX2 608 which will consist of: For present wireless communication pairing status=1 (paired), if pairing status check=0 (not paired), status of parking is set to 1 (parked). Present wireless communication status changed to 0. Parking status, time, and location is sent from fixed communication device A00 via wireless communication unit AB0 to mobile communication device software application C00, which in turn forwards this data via the internet to a parking data storage server D00 as shown in FIG. 5. In one embodiment, gathering parking behavior of a first individual; mapping the parking behavior of the first individual and disseminating the information using the device and system to communicate using social media and membership base; and predicting a parking spot for the individual using their device to communicate to a second individual is performed.

FIG. 9, to which reference is now made, demonstrates Step XX3 610 which will consist of: For present wireless communication pairing status=0 (not paired), if pairing status check=0 (not paired), then status of parking is set to 1 (parked).

FIG. 10, to which reference is now made, demonstrates Step XX4 612 which will consist of: For present wireless communication pairing status=0 (not paired), if pairing status check=1 (paired), status of parking is set to 2 (parking about to become available). Present wireless communication pairing status changed to 1. Parking status, time, and location is sent from fixed communication device A00 via wireless communication unit AB0 to mobile communication device software application C00, which in turn forwards this data via the internet to a parking data storage server D00 as shown in FIG. 5.

The above process as shown in FIGS. 6, 7, 8, 9, and 10, as enabled by the sensing unit described herein, comprise a deterministic method of predicting specifically available parking space before actual availability occurs. The process works because there is a significant duration between return to vehicle and time of actual driving (i.e. vacating parking space).

Present embodiment of novel fixed communication device A01 is shown in FIG. 11. FIG. 11 also shows one possible alternate form of novel fixed communication device B01. Novel fixed communication device 1102 A01 comprises an SAE J1962 interface, a Bluetooth 3.0 chipset, and a Mediatek 3333 GPS chipset. Other embodiments include Bluetooth 4.0 and succeeding chipsets or alternative Mediatek, SiRF, and other GPS chipsets.

Bluetooth 3.0 and sub-versions of this standard are preferable for use as the sensing unit because of the ubiquity of Bluetooth 3.0 and sub-version support among commercially available mobile communication devices 1106. The SAE J1962 interface is preferable for use in the fixed communications device 1102 and 1108 because it is the only plug-in interface which is reliably always on in all commercially available vehicles. The SAE J1962 interface plugs into any vehicle older than 1996 via a US and EU lawfully mandated on board diagnostics port. The SAE J1962 interface, when coupled with an interpreter integrated circuit, also permits access to additional data from the vehicle on board diagnostics system which can be used to further improve the function of the sensing unit.

The fixed communication device 1102 and 1108 can also be permanently installed into an automobile as part of the electrical system either during or after manufacturing. The fixed communication device 1102 and 1108 can be replaced wholly or partly by existing automobile hardware if the corresponding automobile hardware is enabled to be constantly active.

Accurate determination of parking status by the sensing unit and accurate parking GPS location from the locater unit permits automation of delivery of parking regulation data, determination if adjacent parking is legal according to parking regulation data (Can I Park Here?) and also the automatic setup and dismissal of parking ticket avoidance reminders.

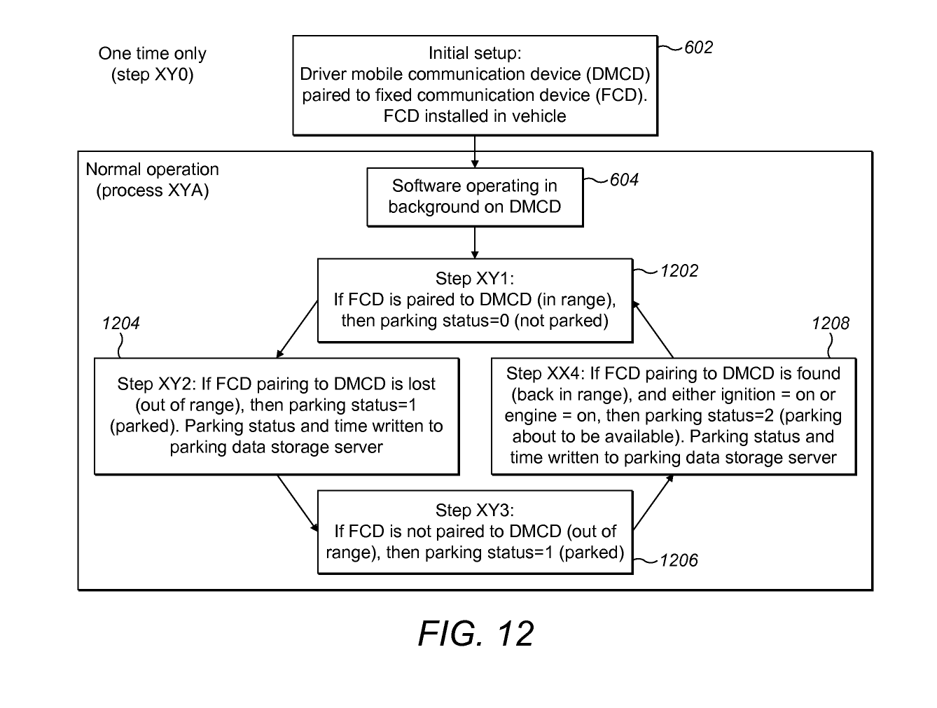

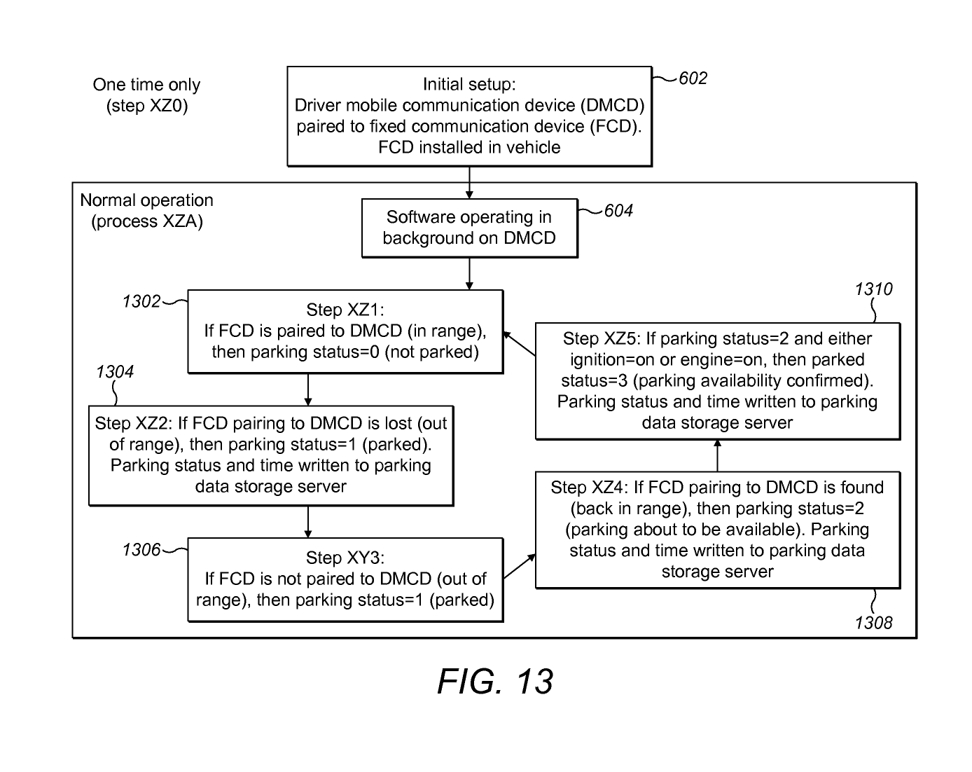

Alternate processes are shown in FIGS. 12 and 13 where information from the vehicle on board diagnostic system is used to further refine the deterministic method of predicting an available parking space before actual availability occurs.

FIG. 12 shows the flow chart steps for parking prediction. The Driver Mobile Communication Device (DMCD) which is a smart edge device is paired to Fixed Communication Device (FCD) installed in the vehicle 602. The software operates in background on DMCD 604. If FCD is paired to DMCD (within the range), then the parking status is that the vehicle is not parked 1202. If FCD pairing to DMCD is lost (out of range) 1204, then the parking is done. This means that the person has parked and left, therefore the parking status and time can be written to the parking data storage server. If FCD is not paired to DMCD because it continues to be out of range 1206, the vehicle is deemed to be parked, and the status remains as parked. If FCD finds that DMCD has approached back into the field of influence, and either ignition or engine is on, then the parking status is changed from parked to “about to be available” 1208.

FIG. 13 shows the flow chart steps for parking confirmation. The Driver Mobile Communication Device (DMCD) which is a smart edge device is paired to Fixed Communication Device (FCD) installed in the vehicle 602. The software operates in background on DMCD 604. If FCD is paired to DMCD (within the range), then the parking status is that the vehicle is not parked 1302. If FCD pairing to DMCD is lost (out of range) 1304, then the parking is done. This means that the person has parked and left, therefore the parking status and time can be written to the parking data storage server. If FCD is not paired to DMCD because it continues to be out of range 1306, the vehicle is deemed to be parked, and the status remains as parked. If FCD finds that DMCD has approached back into the field of influence, the parking status is “about to be available” and is written into the server. If FCD finds the ignition or engine is on, then the parking availability is confirmed 1310, and the parking status is changed from “about to be available” to “confirmed” 1310.

Historical parking behavior gathered by the system and method may be used to also provide statistical prediction of parking availability. Parking behavior is not limited to automobiles, but may be applied to any other form of motor vehicle including aircraft, watercraft, motorcycles, recreational vehicles, trains and so forth. Preset indicators of the driver's vehicle size may be used to further refine usability of predicted parking spaces as communicated to other social parking users. The parking determination process may be used to determine operating status of vehicle. Operating status combined with destination, a route to destination, and communication with a central server, can be used for automated social enablement of ride sharing.

The system (fixed locator device, sensing unit and the software) may be integrated with vehicle navigation and also vehicle information display unit in order to facilitate navigation to available parking. The system and method may be used to gather traffic behavior during periods of vehicle active operation. The system and method permits much greater detail in gathered behavior such as lane specific behavior as well as mode specific behavior such as when accelerating or braking.

Historical parking data collected using the system may be licensed to third parties for integration with existing services like navigation or commercial delivery route planning. System and method may be used to communicate or inform drivers about areas which are safe to park their vehicle in order to minimize risk of theft and vandalism. System may be used as a secondary safeguard to prevent vehicle operation by unauthorized users. System may be licensed for the purpose of customizing vehicle insurance policies with actual vehicle use patterns. System and method may be used to monitor and communicate automobile maintenance requirements.

System may be used to monitor compliance with traffic or parking restriction zones, including vehicle population limits. System may be used to collect payments for use of restricted traffic or parking restriction zones. System may be used to facilitate parking and vehicle access as well as to monitor and manage vehicle sharing. System, when combined with estimated time of arrival, may be used to proactively manage and monitor compliance with user's schedule calendar.

System, when combined with estimated time of arrival, may be used to socially communicate user's on time or tardiness status for scheduled events to other participants. System, when combined with estimated time of arrival and user calendar, can be used to automatically recommend parking search pattern based on level of urgency vs. cost sensitivity. System and method may be used to remember where user's vehicle was parked. System and method, when combined with user defined zones, can be used to initiate automatic actions like opening garage doors or other household appliance activities.

Device, System and method may be used by delivery fleet management to correlate parking behavior with parking infractions, and then to adjust delivery fleet parking behavior to optimize parking infraction expense. Historical parking data collected by the system may be licensed for the management of traffic and parking infrastructure.

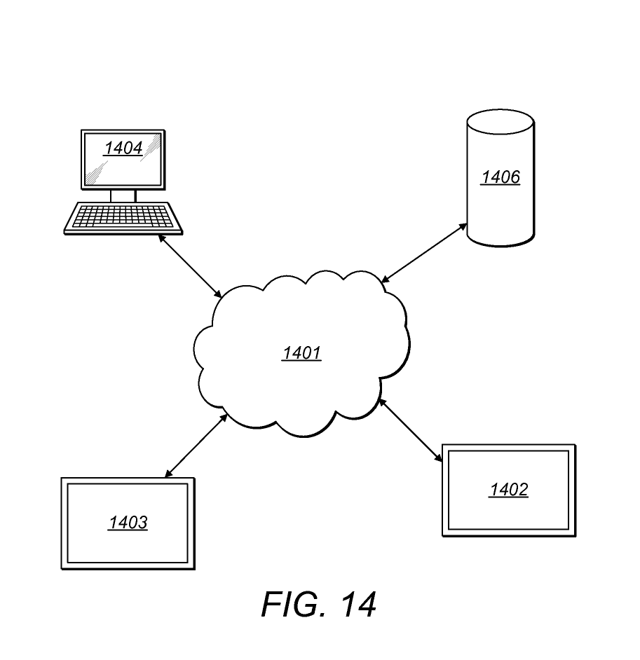

FIG. 14 is a systematic view of an integrated system for data management illustrating communication between user and the server through a network, according to one embodiment. In one embodiment a user or multiple users may connect to the server that hosts the multimedia tool in the system. In another embodiment, the user hard ware such as a PDA, mobile device such as tablets etc., computer or a mobile phone or any wireless device, or an electronic book (e-book) may be connected with each other or work independently to allow the user to use the multimedia tool for education, learning, and/or interactively playing games. The network 1401 may be a LAN, WAN, mobile, telecommunications, internet, intranet, WiFi and/or ZigBee network, etc. The user/individual 1404, 1403 and 1402 and so on may be an individual, a parent, a scientist, an author, but not limited to these group of folks only. The user and individual are used interchangeably and mean the same. The user may be any person who accesses the data management system for various activities as discussed in different case scenarios in the supporting figures. The cloud server 1406 may also be used for storing data and processing. The data management tool may be accessed to search, create content, upload content, view content, use the content and save and/or delete the content. The server may be stand alone, cloud based or hosted services.

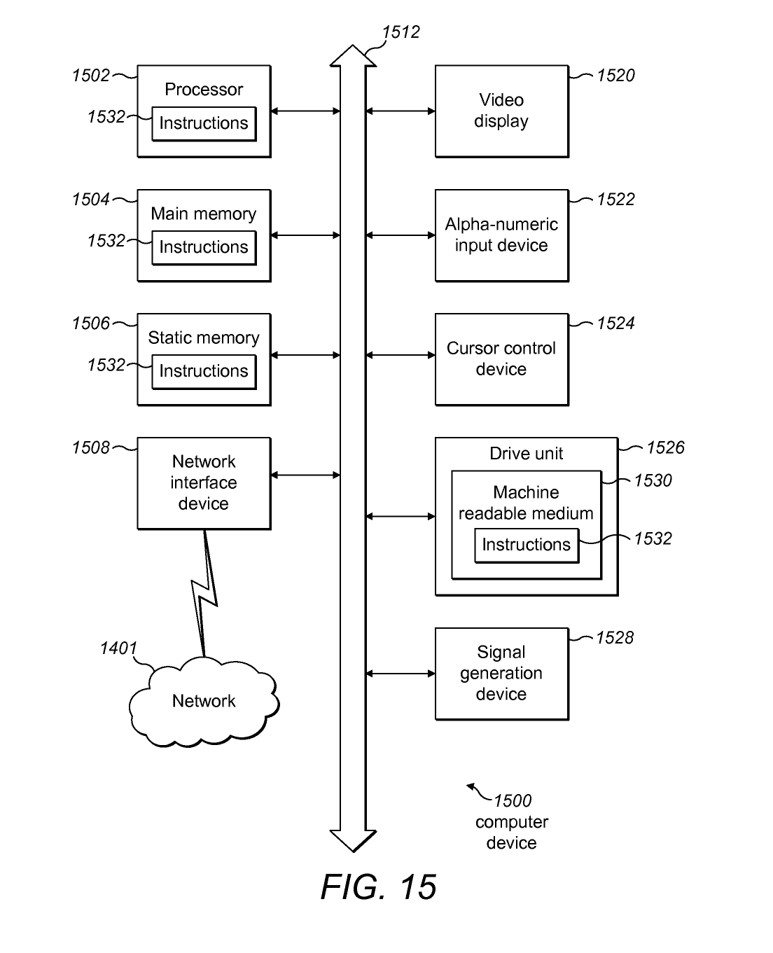

FIG. 15 is a diagrammatic system view 1500 of a computer device view in which any of the embodiments disclosed herein may be performed, according to one embodiment. Particularly, the computer system view 1500 illustrates a processor 1502, a main memory 1504, a static memory 1506, a bus 1512, a video display 1520, an alpha-numeric input device 1522, a cursor control device 1524, a drive unit 1526, a signal generation device 1528, a network interface device 1508, a machine readable medium 1530, instructions 1532, and a network 1401, according to one embodiment.

The computer system view 1500 may indicate a personal computer and/or a data processing system (e.g., server) in which one or more operations disclosed herein are performed. The processor 1502 may be microprocessor, a state machine, an application specific integrated circuit, a field programmable gate array, etc. The main memory 1504 may be a dynamic random access memory and/or a primary memory of a computer system. The static memory 1506 may be a hard drive, a flash drive, and/or other memory information associated with the computer system. The bus 1512 may be an interconnection between various circuits and/or structures of the computer system. The video display 1520 may provide graphical representation of information on the data processing system. The alpha-numeric input device 1522 may be a keypad, keyboard and/or any other input device of text (e.g., a special device to aid the physically handicapped). The cursor control device 1524 may be a pointing device such as a mouse.

The drive unit 1526 may be a hard drive, a storage system, and/or other longer term storage subsystem. The signal generation device 1528 may be a bios and/or a functional operating system of the data processing system. The network interface device 1508 may be a device that may perform interface functions such as code conversion, protocol conversion and/or buffering required for communication to and from a network. The machine readable medium 1530 may provide instructions on which any of the methods disclosed herein may be performed. The instructions 1532 may provide source code and/or data code to the processor 1502 to enable any one/or more operations disclosed herein.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments are not described with reference to any particular programming language. It will be appreciated that a variety of programming languages may be used to implement the teachings of the invention as described herein. Various machine readable media, computer and processors may be used in this system and method described along with the device.

What is claimed is:

1. A device, comprising:
a fixed communication device comprising of at least one of a locator unit to receive and process information regarding a current location, a wireless communication unit for transmitting a data and a sensing unit to determine parking status based on proximity of a driver device to the fixed communication device; and
a mobile communication device for information transfer to and from the fixed communications device.

2. The device of claim 1, further comprising:
a software program on the mobile communication device serves as the user interface; and
a server connected to the fixed communications device.

3. The device of claim 2, wherein said device is a means to determine a parking status without proactive user input.

4. The device of claim 2, wherein said device is a means to determine at least one of a presence or an absence of the driver in a vehicle.

5. The device of claim 2, wherein the fixed communication device operates within a specific range.

6. A method, comprising:
installing a fixed communication device on a vehicle and gathering information about the vehicle from the fixed communication device; and
pairing the fixed communication device with a driver device and establishing a data connection within a specific range to present at least one of an out of range data, in range data, predicting parking status, confirming parking status and vacancy status for parking the vehicle.

7. The method of claim 6, further comprising:
gathering parking behavior of a first individual;
mapping the parking behavior of the first individual and disseminating the information using the device and system to communicate using social media and membership base; and
predicting a parking spot for the individual using their device to communicate to a second individual.

8. The method of claim 6, wherein the specific range is equal to zero then the vehicle is not parked.

9. The method of claim 6, wherein the specific range is equal to 1 then the vehicle is parked.

10. The method of claim 6, wherein the specific range is equal to 2 then it the vehicle is about to leave and a parking spot is available.

11. A system, comprising:
a vehicle having a sensing unit to predict expected changes in said parking status based on a physical sensing of driver proximity to vehicle;
a device to monitor the efficient parking search by communicating the future availability of parking before parking spots actually vacate;
a software tool to manage the data gathered using the device; and
a membership enrollment database to store and distribute a data produced by the system.

12. The system of claim 11, further comprising:
a monitoring system to create data for at least one of an out of range data, in range data, predicting parking status, confirming parking status and vacancy status for parking the vehicle.

13. The system of claim 11, further comprising:
a security system to monitor a driver behavior for a transport vehicle, parking pattern and a parking requirement.

14. The system of claim 11, further comprising:
a pairing system to pair a fixed communication device and a driver device within a specific range to predict a parking occupancy and vacancy data without user interference.

15. The system of claim 14, wherein the specific range determines if a vehicle is parked, parking spot is open and a vehicle is about to leave.
